(19) United States
(12) Patent Application Publication
(10) Pub. No.: US 2026/0310020 A1
(43) Pub. Date: Oct. 8, 2026

(54) DISPLAY PANEL, ALIGNMENT DEVIATION MEASUREMENT METHOD, AND DISPLAY DEVICE

(71) Applicants: Fuzhou BOE Optoelectronics Technology Co., Ltd., Fuzhou, Fujian (CN); BOE Technology Group Co., Ltd., Beijing (CN)

(72) Inventors: Xin Fang, Beijing (CN); Wenchao Wang, Beijing (CN); Xiaolong Chen, Beijing (CN); Lixia Zhang, Beijing (CN)

(73) Assignees: Fuzhou BOE Optoelectronics Technology Co., Ltd., Fuzhou, Fujian (CN); BOE Technology Group Co., Ltd., Beijing (CN)

(21) Appl. No.: 19/483,435

(22) PCT Filed: Apr. 17, 2024
(86) PCT No.: PCT/CN2024/088441

§ 371 Date: Nov. 11, 2025

(30) Foreign Application Priority Data
May 22, 2023 (CN) 202310579503.8

(51) Int. Cl. G02F 1/1333; G01B 11/27

(52) U.S. Cl. CPC G02F 1/133354; G01B 11/27

(57) ABSTRACT

The present disclosure provides a display panel. The display panel includes a first substrate and a second substrate. The display panel includes a display area and a non-display area, at least one mark area is arranged in the non-display area, each mark area includes at least one assembling mark group, each assembling mark group is configured to detect an assembling deviation in a preset direction and includes: a first assembling mark arranged on a side of the first substrate close to the second substrate and in a comb shape, and a second assembling mark arranged on a side of the second substrate close to the first substrate and in the comb shape, comb teeth of the first assembling mark face the second assembling mark, comb teeth of the second assembling mark face the first assembling mark, and a length direction of the comb teeth is perpendicular to the preset direction.

### CROSS-REFERENCE TO RELATED APPLICATION

The present disclosure claims the priority of Chinese patent application filed on May 22, 2023 before the CNIPA, China National Intellectual Property Administration with the application number of 202310579503.8, and the title of “DISPLAY PANEL, METHOD FOR MEASURING ASSEMBLING DEVIATION, AND DISPLAY DEVICE”, which is incorporated herein in its entirety by reference.

### FIELD

The present disclosure relates to the field of display technologies, and in particular to a display panel, a method for measuring an assembling deviation, and a display device.

### BACKGROUND

A liquid crystal display (LCD) controls light penetrating a liquid crystal layer by controlling rotation directions and rotation angles of liquid crystal molecules, thereby displaying images of various gray scales. The liquid crystal display has advantages of high picture quality, small size and light weight, and is widely applied in products such as mobile phones, laptop computers, televisions and displays.

The liquid crystal display is formed by assembling an array substrate and a color filter substrate (a color filter) together and injecting liquid crystal into a space between the two substrates. The main preparation processes include a color filter process, an array process and an assembling process. In the assembling process of the array substrate and the color filter substrate, an assembling deviation is inevitable, which will affect the product quality of the liquid crystal display. In practice, it is necessary to accurately measure the assembling deviation of the assembling process.

### SUMMARY

A first aspect of the present disclosure provides a display panel, including: a first substrate and a second substrate, where
the display panel includes a display area and a non-display area, where at least one mark area is arranged in the non-display area, each of the at least one mark area includes at least one assembling mark group, and each of the at least one assembling mark group is configured to detect an assembling deviation in a preset direction;
the assembling mark group includes: a first assembling mark arranged on a side of the first substrate close to the second substrate and in a comb shape, and a second assembling mark arranged on a side of the second substrate close to the first substrate and in the comb shape,
where comb teeth of the first assembling mark face the second assembling mark, comb teeth of the second assembling mark face the first assembling mark, and a length direction of the comb teeth is perpendicular to the preset direction.

In an optional example, the non-display area includes a border area, and the border area includes a sub-border area located on at least one side of the display area,
where a plurality of mark areas are located in all or part of the sub-border area.

In an optional example, the non-display area includes a border area, the border area includes a sub-border area located on a side of the display area, the sub-border area includes at least two mark areas, the at least two mark areas are arranged close to two different sides of the sub-border area, and the two different sides are oppositely arranged in an extension direction of the sub-border area,
where the assembling mark groups in the at least two mark areas are configured to detect an assembling deviation in two mutually perpendicular preset directions.

In an optional example, the at least one assembling mark group included in the mark area includes at least one of a first assembling mark group or a second assembling mark group, a preset direction corresponding to the first assembling mark group is a first direction, and a preset direction corresponding to the second assembling mark group is a second direction,
where the first direction and the second direction are two mutually perpendicular directions.

In an optional example, where the non-display area includes a border area, the border area includes one or more sub-border areas located on at least one side of the display area, and the at least one mark area is located in at least one of the sub-border areas,
where in a third assembling mark group in a plurality of assembling mark groups, the first assembling mark and the second assembling mark include a plurality of comb teeth which are continuous and uninterrupted, and
where a preset direction corresponding to the third assembling mark group is parallel to an extension direction of the sub-border area where the third assembling mark group is located.

In an optional example, the non-display area includes a border area, the border area includes a sub-border area located on one side of the display area, and the at least one mark area is all located in the sub-border area,
where a fourth assembling mark group in a plurality of assembling mark groups includes: a plurality of sub-assembling mark groups arranged at intervals in an extension direction of the sub-border area, and the plurality of sub-assembling mark groups are obtained by segmenting the comb teeth of the first assembling mark and the comb teeth of the second assembling mark, and
where a preset direction corresponding to the fourth assembling mark group is perpendicular to the extension direction of the sub-border area.

In an optional example, a tooth width of the comb teeth in the first assembling mark is greater than or equal to 5 μm, and a tooth width of the comb teeth in the second assembling mark is greater than or equal to 5 μm.

In an optional example, a spacing distance between a plurality of comb teeth in the first assembling mark is equal, and the plurality of comb teeth have a same size; and
a spacing distance between a plurality of comb teeth in the second assembling mark is equal, and the plurality of comb teeth have a same size.

In an optional example, a first spacing distance between every two adjacent comb teeth in the first assembling mark is greater than or equal to 5 μm, and a second spacing distance between every two adjacent comb teeth in the second assembling mark is greater than or equal to 5 μm.

In an optional example, a value of the first spacing distance is the same as or different from a value of the second spacing distance.

In an optional example, a value of the first spacing distance is not equal to a value of the second spacing distance, and the assembling mark group further includes: a plurality of scale marks, and the plurality of scale marks are located on a side of the first assembling mark away from the second assembling mark or on a side of the second assembling mark away from the first assembling mark,
where two adjacent scale marks pass through at least two comb teeth, and a difference between scales of the two adjacent scale marks is a product of a difference between the first spacing distance and the second spacing distance and a number of comb teeth.

In an optional example, the first spacing distance is different from the second spacing distance, and a difference between the first spacing distance and the second spacing distance is greater than or equal to 0.2 μm and less than or equal to 2 μm.

In an optional example, an orthographic projection of the comb teeth in the first assembling mark on the second substrate partially overlaps with the comb teeth in the second assembling mark.

In an optional example, a size of an overlapping area in a length direction of the comb teeth is greater than or equal to 2 μm and less than a length of the comb teeth.

In an optional example, the first substrate is an array substrate, where the first assembling mark is arranged in a same layer as a metal film layer farthest from the second substrate in the array substrate.

In an optional example, the second substrate is a color filter substrate, where the second assembling mark is arranged in a same layer as a black matrix film layer of the color filter substrate.

In an optional example, a color of the first assembling mark is different from a color of the second assembling mark.

The present disclosure further provides a method for measuring an assembling deviation, applied to the display panel, including:
detecting alignment of the comb teeth of the first assembling mark and the second assembling mark; and
determining an assembling deviation between the first substrate and the second substrate based on a detection result.

In an optional example, determining the assembling deviation between the first substrate and the second substrate based on the detection result includes:
determining target comb teeth that are completely aligned in the first assembling mark and the second assembling mark; and
determining the assembling deviation based on a scale value corresponding to a target scale mark.

The present disclosure further provides a display device, including: the display panel.

The display panel provided by the present disclosure includes a first substrate and a second substrate; where at least one mark area is arranged in the non-display area, each of the at least one mark area includes at least one assembling mark group, and each of the at least one assembling mark group is configured to detect an assembling deviation in a preset direction; the assembling mark group includes: a first assembling mark arranged on a side of the first substrate close to the second substrate and in a comb shape, and a second assembling mark arranged on a side of the second substrate close to the first substrate and in the comb shape, and comb teeth of the first assembling mark face the second assembling mark, comb teeth of the second assembling mark face the first assembling mark, and a length direction of the comb teeth is perpendicular to the preset direction.

Since each assembling mark group of the present disclosure includes the first assembling mark located on the first substrate and in the comb shape, and the second assembling mark located on the second substrate and in the comb shape, where the comb teeth of the first assembling mark and the comb teeth of the second assembling mark face each other, the assembling deviation of the first substrate and the second substrate in the preset direction can be determined by detecting the alignment of the comb teeth of the first assembling mark and the second assembling mark. Moreover, since the comb teeth are relatively fine in morphology, the flexibility of the spatial layout of the comb teeth is relatively strong. When the comb teeth are used as the assembling mark and the alignment of the comb teeth is used for measuring the assembling deviation, the space occupation of the border area of the display panel can be reduced, and thus the comb teeth can be applied to display panels with narrow borders or fewer borders, for example, display panels with only one border.

The above description is only an overview of the technical solutions of the present disclosure. In order to understand technical means of the present disclosure more clearly, it can be implemented according to contents of the specification, and in order to make the above and other purposes, features and advantages of the present disclosure more obvious and understandable, the specific embodiments of the present disclosure are provided below.

### BRIEF DESCRIPTION OF THE DRAWINGS

In order to more clearly explain technical solutions in the embodiments of the present disclosure or the related art, accompanying drawings needed in the description of the embodiments or the related art will be briefly introduced below. Obviously, the accompanying drawings described below are only some embodiments of the present disclosure. For a person skilled in the art, other accompanying drawings can be obtained according to these accompanying drawings without creative labor. It should be noted that proportions in the accompanying drawings are only for illustration and do not represent actual proportions.

FIG. 1 schematically shows a schematic diagram of positions where assembling marks are arranged in the related art.

FIG. 2 schematically shows a top plan view schematic diagram of a first substrate in a display panel in an embodiment of the present disclosure.

FIG. 3 schematically shows a top plan view schematic diagram of a second substrate in a display panel in an embodiment of the present disclosure.

FIG. 4 schematically shows a top view schematic diagram of a display panel obtained by assembling a first substrate and a second substrate in the present disclosure.

FIG. 5a schematically shows a top view schematic diagram of a display panel shown in an example A in an embodiment of the present disclosure.

FIG. 5b schematically shows a top view schematic diagram of a display panel shown in an example B in an embodiment of the present disclosure.

FIG. 5c schematically shows a top view schematic diagram of a display panel shown in an example C in an embodiment of the present disclosure.

FIG. 5d schematically shows a top view schematic diagram of a display panel shown in an example D in an embodiment of the present disclosure.

FIG. 5e schematically shows a top view schematic diagram of a display panel shown in an example E in an embodiment of the present disclosure.

FIG. 6a schematically shows a top plan view schematic diagram of a display panel when an assembling mark group is segmented in a horizontal direction.

FIG. 6b schematically shows a top plan view schematic diagram of a display panel when an assembling mark group is segmented in a longitudinal direction.

FIG. 7 schematically shows a top view schematic diagram of an assembling mark group for detecting an assembling deviation in a horizontal direction.

FIG. 8 schematically shows a principle schematic diagram of measuring an assembling deviation in one case.

FIG. 9 schematically shows a top view schematic diagram of an assembling mark group with scale marks.

FIG. 10 schematically shows a schematic diagram of a method for measuring an assembling deviation of a display panel in the present disclosure.

### DESCRIPTIONS OF REFERENCE NUMERALS

100. First substrate; 101. First display area; 102. First border area; 103. First assembling mark; 200. Second substrate; 201. Second display area; 202. Second border area; 203. Second assembling mark; 300. Mark area; 400. Display panel; 401. Display area; 402. Border area; 403. Assembling mark group; 4021: First sub-border area; 4022. Second sub-border area; 4023. Third sub-border area; 4024. Fourth sub-border area; 500. Scale mark.

### DETAILED DESCRIPTION

In order to make the objects, the technical solutions and the advantages of the embodiments of the present disclosure clearer, the technical solutions of the embodiments of the present disclosure can be clearly and completely described below with reference to the drawings of the embodiments of the present disclosure. Apparently, the described embodiments are merely certain embodiments of the present disclosure, rather than all of the embodiments. All of the other embodiments that a person skilled in the art obtains on the basis of the embodiments of the present disclosure without paying creative work fall within the protection scope of the present disclosure.

In the related art, one or more assembling marks are generally arranged in a liquid crystal display to measure assembling deviations. However, with the development of display devices and the aesthetic requirements of the display devices, more and more narrow bezel devices have appeared, most of which are three-sided or even four-sided borderless products, thereby providing less and less space for the assembling marks. In practice, it is necessary to give up measuring the assembling deviation in one direction to deal with display devices with relatively small space.

In the related art, one or more required assembling marks are generally allowed to be arranged at edge positions of a panel where an array substrate and a color filter substrate overlap, for example, left and right sides of a binding side (also known as a data pad (DP) side) of a display side and positions in the middle that do not interfere with a driving signal. The assembling mark is generally a rectangular frame, which is arranged on a border of a display device, but a size of the rectangular frame is generally relatively large. For example, it is necessary to mark a large rectangular frame on the array substrate, a small rectangular frame or a rectangular frame with the same size on the color filter substrate, and determine an assembling deviation based on a positional relationship between the two rectangular frames. In this case, if there is not enough space at the edge position, there is not enough space to arrange the rectangular frame.

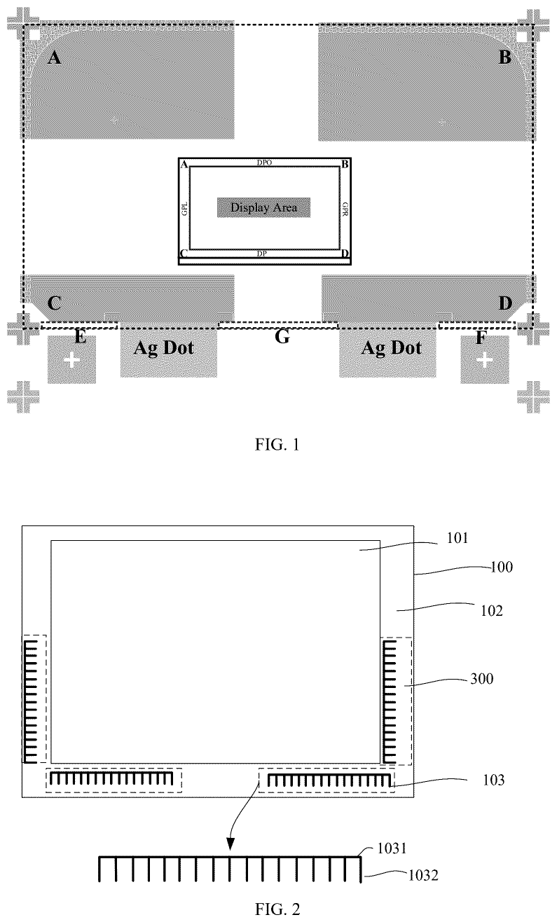

Referring to FIG. 1, FIG. 1 shows a schematic diagram of positions where assembling marks are arranged in the related art. FIG. 1 takes a gate gate driver on array (Gate GOA) type display panel as an example, and the display panel includes a display area and a border area surrounding the display area. In a direction of overlooking the display panel, the border area includes a binding side DP in a horizontal direction and an unbinding side DPO (data pad opposite) opposite to the binding side. A data driving circuit is bound on the binding side, and an area where the data driving circuit is not bound on the binding side includes a left area E located on a left side, a right area F located on a right side, and a middle area G. Rectangular frame shaped assembling marks can be arranged in the left area E, the right area F and the middle area G.

However, since it belongs to a narrow bezel display panel, there are no black adhesive frames on the unbinding side and the left and right sides near the display area (areas in a longitudinal direction of the border area), and thus it is not suitable to arrange the assembling marks. In addition, the rectangular frame is relatively large, and thus the assembling marks can only be arranged in the horizontal direction to detect the assembling deviation in the horizontal direction, and the measurement of assembling deviations in the longitudinal direction is abandoned. Therefore, for display panels that require edge aesthetics, for example, three-sided or even four-sided borderless products, the detection of the assembling deviations in one dimension direction is missing, resulting in relatively weak monitoring of the assembling deviations of products and a lack of relatively high quality assurance for the products.

Of course, the above FIG. 1 only exemplifies the case that the detection of the assembling deviations in the longitudinal direction is missing in the related art. In practice, for different types of display panels, it also includes the case that the detection of the assembling deviations in the horizontal direction is missing. In summary, in the related art, for display panels with limited space in the border area, how to arrange the assembling marks to detect the assembling deviations from a plurality of dimension directions is a main problem facing the industry at present.

In view of this, the present disclosure proposes a novel design for assembling marks. The main idea is that the assembling marks are designed as comb shaped marks, comb teeth of the assembling marks on a first substrate 100 and a second substrate 200 of a display panel 400 face each other, so that an assembling deviation can be measured through the alignment of the comb teeth, that is, the assembling deviation in a corresponding preset direction can be measured through opposite directions of the comb teeth of the two assembling marks. Since the comb teeth are relatively fine in morphology, the flexibility of the spatial layout of the comb teeth is relatively strong. Even under the condition of limited space, the aim of measuring the assembling deviation in a plurality of preset directions can be achieved by arranging the comb teeth with different orientations, and thus the space occupation of the border area 402 of the display panel 400 can be reduced, and the comb teeth can be applied to display panels with narrow borders or fewer borders, for example, the display panel 400 with only one border.

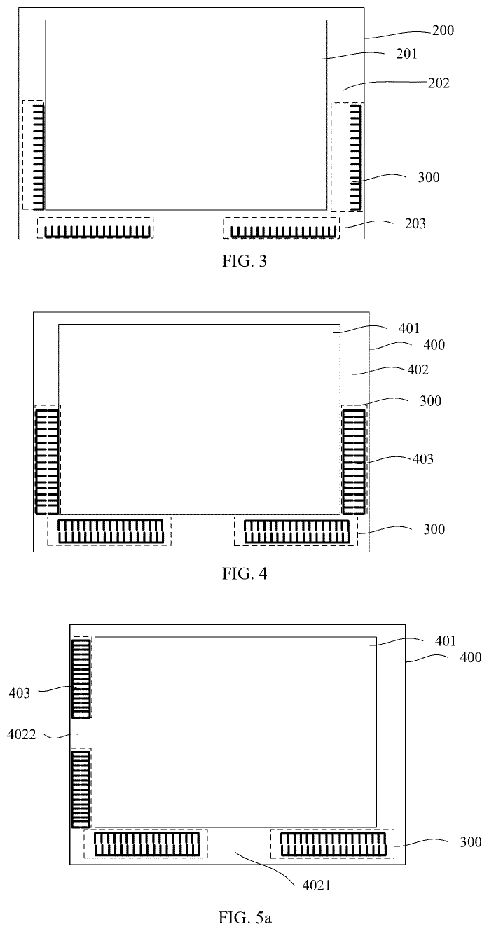

Referring to FIG. 2, FIG. 3 and FIG. 4, FIG. 2 shows a top plan view schematic diagram of a first substrate 100 in a display panel 400 in an embodiment of the present disclosure, FIG. 3 shows a top plan view schematic diagram of a second substrate 200 in a display panel 400 in an embodiment of the present disclosure, and FIG. 4 shows a top view schematic diagram of a display panel obtained by assembling a first substrate and a second substrate in the present disclosure. As shown in FIG. 2 to FIG. 4, the display panel in the embodiment includes: a first substrate 100 and a second substrate 200,
where the display panel 400 includes a display area and a non-display area, where at least one mark area 300 is arranged in the non-display area, each of the at least one mark area 300 includes at least one assembling mark group 403, and each of the at least one assembling mark group 403 is configured to detect an assembling deviation in a preset direction;
the assembling mark group 403 includes: a first assembling mark 103 arranged on a side of the first substrate 100 close to the second substrate 200 and in a comb shape, and a second assembling mark 203 arranged on a side of the second substrate 200 close to the first substrate 100 and in the comb shape,
where comb teeth of the first assembling mark 103 face the second assembling mark 203, comb teeth of the second assembling mark 203 face the first assembling mark 103, and a length direction of the comb teeth is perpendicular to the preset direction.

In the embodiment, the display panel 400 includes the first substrate 100 and the second substrate 200. The first substrate 100 may be an array substrate, and the second substrate 200 may be a color filter substrate; or the first substrate 100 may be a color filter substrate, and the second substrate 200 may be an array substrate. The first substrate 100 and the second substrate 200 can be obtained by making corresponding structural layers according to their respective manufacturing processes. After the first substrate 100 and the second substrate 200 are obtained, an assembling process may be performed, for example, the color filter substrate and the array substrate are combined together to finally form a display panel 400 with a certain size by a serial of processes of alignment film coating, rubbing alignment, one drop filling (ODF), assembling, cutting, and the like.

The first substrate 100 includes a first display area 101 and a non-display area adjacent to the first display area 101, and the non-display area includes a first border area 102. The second substrate 200 may include a second display area 201 and a non-display area adjacent to the second display area 201, and the non-display area includes a second border area 202. After the first substrate 100 and the second substrate 200 are aligned, the first display area 101 corresponds to the second display area 201. Specifically, an orthographic projection of the first display area 101 on the second substrate 200 may overlap with the second display area 201, and an orthographic projection of the first border area 102 on the second substrate 200 may overlap with the second border area 202; or an orthographic projection of the first border area 102 on the second substrate 200 may overlap with the second border area 202.

Of course, in some embodiments, the non-display area may also include a transition area. Specifically, the transition area is located between the border area and the display area, and is used to transition from the border area to the display area.

After the first substrate 100 and the second substrate 200 are aligned, the first display area 101 and the second display area 201 are opposite to form a display area 401 of the display panel 400, and the first border area 102 and the second border area 202 are opposite to form a border area 402 of the display panel 400. The border area 402 is generally used to lay data lines and signal lines, and the display area 401 is used to perform screen display.

In some examples, the border area 402 can surround the display area 401, that is, the display area 401 is surrounded by the border area 402. Alternatively, the border area 402 can surround a part of the display area 401, that is, a part of the display area 401 is arranged adjacent to the border area 402. For example, for a one-sided to three-sided borderless display panel 400, only one side of the display area 401 has the border area 402.

At least one mark area 300 is arranged on the non-display area. Specifically, at least one mark area 300 can be arranged in the border area 402 of the non-display area, and in the case of having a plurality of mark areas 300, the plurality of mark areas 300 can be spaced apart from each other. All the mark areas 300 can be located on a DP side of the border area 402, or on a non DP side of the border area 402; or some of the mark areas 300 can be located on the DP side of the border area 402, and others are located on the non DP side of the border area 402. Specifically, there is no restriction here.

The mark areas 300 are used to arrange assembling marks, and each of the mark areas 300 can be provided with one or more assembling mark groups 403. It should be noted that the first assembling mark 103 on the first substrate 100 and the second assembling mark 203 on the second substrate 200 together form an assembling mark group 403. The assembling mark group 403 is used to detect an assembling deviation in a preset direction.

In some examples, a mark area 300 may include a plurality of assembling mark groups 403, and different assembling mark groups 403 can be used to detect assembling deviations in different preset directions. In this case, length directions of the comb teeth in different assembling mark groups 403 (that is, orientations of the comb teeth) are different. For example, from a top view direction of the display area of the display panel 400, the preset direction may include a horizontal direction and a longitudinal direction, and thus two assembling mark groups 403 can be arranged in a mark area 300, where the orientation of the comb teeth of the first assembling mark 103 and the second assembling mark 203 in one of the two assembling mark groups 403 is longitudinal for detecting the assembling deviation in the horizontal direction; and the orientation of the comb teeth of the first assembling mark 103 and the second assembling mark 203 in another assembling mark group 403 is horizontal for detecting the assembling deviation in the longitudinal direction.

In other examples, as shown in FIG. 2, FIG. 3 and FIG. 4, a mark area 300 may only include one assembling mark group 403, and the assembling mark group 403 can detect an assembling deviation in a preset direction. Different mark areas 300 may be provided with assembling mark groups 403 for detecting assembling deviations in different preset directions. For example, the orientation of the comb teeth of the first assembling mark 103 and the second assembling mark 203 in the assembling mark group 403 arranged in a mark area 3001 is longitudinal for detecting the assembling deviation in the horizontal direction; and the orientation of the comb teeth of the first assembling mark 103 and the second assembling mark 203 in the assembling mark group 403 arranged in a mark area 3002 is horizontal for detecting the assembling deviation in the longitudinal direction.

In the embodiment, each assembling mark group 403 includes a first assembling mark 103 located on the first substrate 100 and a second assembling mark 203 located on the second substrate 200, where the first assembling mark 103 is arranged on a side of the first substrate 100 close to the second substrate 200, and the second assembling mark 203 is arranged on a side of the second substrate 200 close to the first substrate 100. In a specific implementation, the first assembling mark 103 can be arranged in a same layer as a film layer in the first substrate 100 except for a film layer covering the whole substrate, and the second assembling mark 203 can be arranged in a same layer as a film layer in the first substrate 200 except for a film layer covering the whole substrate. Specifically, what kind of film layer is arranged in the same layer can be determined according to actual needs.

It should be noted that the expression of being arranged in a same layer herein may mean that the assembling mark is formed in the same forming process as the film layer.

Moreover, for the convenience of observing the alignment of the comb teeth in the assembling mark group 403 after assembling, in a detection direction of the assembling deviation, that is, in an observation direction of observing the assembling mark group 403 by users, all film layers formed near an observer in the first assembling mark 103 can be transparent, and all film layers formed near the observation direction in the second assembling mark 203 can be transparent, thereby facilitating the observation of the assembling mark.

In the embodiment, the first assembling mark 103 and the second assembling mark 203 in each assembling mark group 403 are comb shaped. As shown in FIG. 2, FIG. 3 and FIG. 4, the comb shaped assembling mark may include a line 1031 extending in the preset direction, and a plurality of comb teeth 1032 arranged on one side of the line, where the plurality of comb teeth are arranged at intervals on one side of the line. Since it is necessary to measure the assembling deviation between the first substrate 100 and the second substrate 200 according to the alignment of the comb teeth, the comb teeth of the first assembling mark 103 on the first substrate 100 need to face the comb teeth of the second assembling mark 203 on the second substrate 200, as shown in FIG. 4. The comb teeth of the first assembling mark 103 and the comb teeth of the second assembling mark 203 need to face each other when assembling, and thus they can point to each other after alignment to determine the alignment of the comb teeth.

Of course, in order to measure the assembling deviation, in an assembling mark group 403, the comb teeth of the first assembling mark 103 and the comb teeth of the second assembling mark 203 can be adapted to each other in size, for example, the comb teeth of the first assembling mark 103 and the comb teeth of the second assembling mark 203 can be the same in spacing, a comb length and a comb width.

According to the display panel 400 in the embodiment of the present disclosure, each assembling mark group 403 includes the first assembling mark 103 located on the first substrate 100 and in the comb shape, and the second assembling mark 203 located on the second substrate 200 and in the comb shape, where the comb teeth of the first assembling mark 103 and the comb teeth of the second assembling mark 203 face each other, the assembling deviation of the first substrate 100 and the second substrate 200 in the preset direction can be determined by detecting the alignment of the comb teeth of the first assembling mark 103 and the second assembling mark 203. Moreover, since the comb teeth are relatively fine in morphology, the flexibility of the spatial layout of the comb teeth is relatively strong. When the comb teeth are used as the assembling mark and the alignment of the comb teeth is used for measuring the assembling deviation, the space occupation of the border area 402 of the display panel 400 can be reduced, and thus the comb teeth can be applied to display panels 400 with narrow borders or fewer borders, for example, display panels 400 with only one border.

In some embodiments, as mentioned above, the first substrate 100 can be the array substrate. For the array substrate, the first assembling mark 103 can be arranged in the same layer as other film layers except for the film layer covering the whole array substrate. Further, the first assembling mark 103 can be arranged in the same layer as a metal film layer farthest from the second substrate 200 in the array substrate, for example, a gate film layer (a gate metal layer).

In some embodiments, as mentioned above, the second substrate 200 may be the color filter substrate. For the color filter substrate, the second assembling mark 203 can be arranged in the same layer as other film layers except for the film layer covering the whole color filter substrate. Further, the second assembling mark 203 can be arranged in the same layer as a black matrix film layer of the color filter substrate.

In some embodiments, the first substrate 100 is the array substrate, the second substrate 200 is the color filter substrate, the first assembling mark 103 can be arranged in the same layer as the gate metal layer, and the second assembling mark 203 can be arranged in the same layer as the black matrix film layer. The expression of being arranged in the same layer may mean that the assembling mark and the film layer are formed in a one-time film forming process, and materials used can be the same as or different from the film layer in the same layer, which is not limited here.

In the case where the first assembling mark 103 can be arranged in the same layer as the metal film layer farthest from the second substrate 200 in the array substrate and the second assembling mark 203 can be arranged in the same layer as the black matrix film layer, the manufacturing deviation of the assembling mark group 403 can be avoided, so as to improve the measurement accuracy of the assembling deviation. This is because the first assembling mark 103 is arranged in the same layer as the metal film layer farthest from the second substrate 200, for example, the gate metal layer is first patterned on the first substrate 100, and remaining film layers patterned on the first substrate 100 are formed based on this film layer, due to inevitable errors in a film layer forming process, there may be deviations between the remaining film layers with the film layer first formed, generally about 0.2 μm; if the first assembling mark 103 is prepared in the same layer as the remaining film layers, such deviation will also be inherited, which will lead to the problem that the first assembling mark 103 cannot accurately reflect a film size of the first substrate 100, and thus there will be some manufacturing deviation for the assembling mark group 403 itself, resulting in inaccurate measurement of the assembling deviation.

When the first assembling mark 103 and the second assembling mark 203 are arranged in the same layer as a reference film layer, it can be ensured that the first assembling mark 103 and the second assembling mark 203 are made in the same layer as the reference film layer, which can accurately reflect a mark of a film layer size of the first substrate 100, thereby improving the accuracy of measuring the assembling deviation.

In some embodiments, several methods of arranging the assembling mark group 403 in the border area 402 are described, namely the positions of the mark area 300 are described.

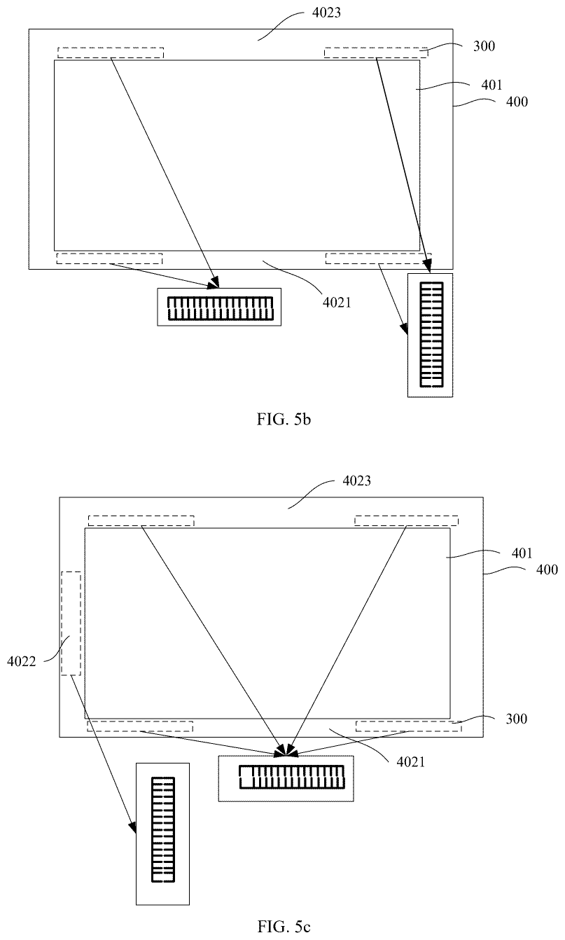

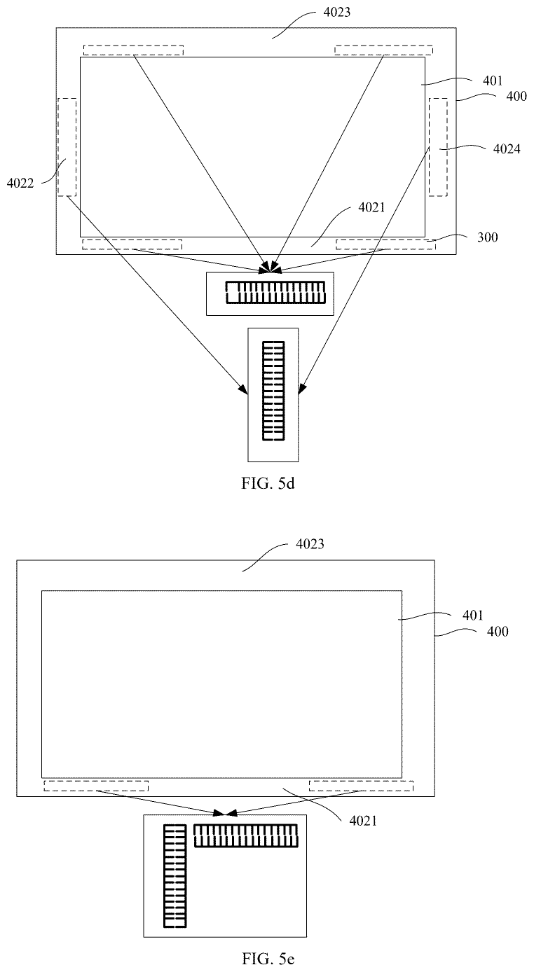

Referring to FIG. 5a to FIG. 5e, FIG. 5a to FIG. 5e show several top view schematic diagrams of a display panel 400. As shown in FIG. 5a to FIG. 5e, the display panel 400 further includes a display area 401, and a border area 402 includes a sub-border area 402 located on at least one side of the display area 401, where a plurality of mark areas 300 are distributed at intervals in at least one side of the sub-border area 402.

In some embodiments, the plurality of mark areas 300 can be distributed at intervals in the plurality of sides of the sub-border area 402, so that the assembling deviations in the preset directions can be detected at a plurality of position points on the display panel 400, thereby improving the accuracy of detecting the assembling deviation.

In a specific example A of the embodiment, the plurality of mark areas 300 can be distributed in the sub-border areas 402 on two adjacent sides of the display area 401, respectively, and one sub-border area 402 may have one or more spaced mark areas 300. As shown in FIG. 5a, the border area 402 includes a first sub-border area 4021 located on one side of the display area 401, and a second sub-border area 4022 adjacent to the first sub-border area 4021. The first sub-border area 4021 includes one or more spaced mark areas 300, and the second sub-border area 4022 includes one or more spaced mark areas 300.

In the example A, a preset direction in which the detection is performed by the assembling mark group 403 arranged in the mark area 300 of the first sub-border area 4021 may be an extension direction of the first sub-border area 4021. As shown in FIG. 5a, the preset direction is the horizontal direction when the display panel 400 is viewed from above. The preset direction in which the detection is performed by the assembling mark group 403 arranged in the second sub-border area 4022 may be an extension direction of the second sub-border area 4022. As shown in FIG. 5a, the extension direction of the second sub-border area 4022 is the longitudinal direction when the display panel 400 is viewed from above.

Using this example A, it is possible to detect the assembling deviation in the horizontal direction under the condition that the comb teeth arranged in the horizontal direction are aligned in the horizontal extension direction of the display panel 400, and to detect the assembling deviation in the longitudinal direction under the condition that the comb teeth arranged in the longitudinal direction are aligned in the longitudinal extension direction of the display panel 400, so that the arrangement of the comb teeth of the assembling mark group 403 can be adapted to the space provided by the sub-border area 402, thereby fully utilizing the space provided by the border area 402.

Of course, in a specific implementation of the example A, the preset direction in which the detection is performed by the assembling mark group 403 arranged in the mark area 300 of the first sub-border area 4021 may include the longitudinal direction and the horizontal direction, or the preset direction in which the detection is performed by the assembling mark group 403 arranged in the second sub-border area 4022 may include the longitudinal direction and the horizontal direction. Alternatively, the preset direction in which the detection is performed by the assembling mark group 403 arranged in the mark area 300 of the first sub-border area 4021 may include the longitudinal direction and the horizontal direction, and the preset direction in which the detection is performed by the assembling mark group 403 arranged in the second sub-border area 4022 may also include the longitudinal direction and the horizontal direction.

In a specific example B of the embodiment, the plurality of mark areas 300 can be distributed in the sub-border areas 402 on two opposite sides of the display area 401, respectively, and one sub-border area 402 may have one or more spaced mark areas 300. As shown in FIG. 5b, the border area 402 includes the first sub-border area 4021 located on one side of the display area 401, and a third sub-border area 4023 opposite to the first sub-border area 4021. The first sub-border area 4021 includes one or more spaced mark areas 300, and the third sub-border area 4023 includes one or more spaced mark areas 300. The number of mark areas 300 included in the first sub-border area 4021 may be different from the number of mark areas 300 included in the second sub-border area 4022.

In one implementation of the example B, the assembling mark groups 403 arranged in the mark areas 300 of the first sub-border area 4021 are used to detect the assembling deviations in two preset directions, and the two preset directions include the extension direction of the first sub-border area 4021 and the extension direction of the second sub-border area 4022 in FIG. 5b. As shown in FIG. 5a, the extension direction of the first sub-border area 4021 is the horizontal direction when the display panel 400 is viewed from above, and the extension direction of the second sub-border area 4022 is the longitudinal direction when the display panel 400 is viewed from above. Similarly, the assembling mark groups 403 arranged in the mark areas 300 of the third sub-border area 4023 can also be used to detect the assembling deviations in two preset directions, namely the longitudinal direction and the horizontal direction.

Specifically, the first sub-border area 4021 includes two mark areas 300, and the third sub-border area 4023 may also include two mark areas 300. In the two mark areas 300 included in the first sub-border area 4021, one mark area 300 is used to arrange the assembling mark group 403 for detecting the assembling deviation in the horizontal direction, and the other mark area 300 is used to arrange the assembling mark group 403 for detecting the assembling deviation in the longitudinal direction. The third sub-border area 402 includes two mark areas 300, one mark area 300 is used to arrange the assembling mark group 403 for detecting the assembling deviation in the horizontal direction, and the other mark area 300 is used to arrange the assembling mark group 403 for detecting the assembling deviation in the longitudinal direction.

In another implementation of the example B, the assembling mark groups 403 arranged in the mark areas 300 of the first sub-border area 4021 are used to detect the assembling deviations in two preset directions, and the assembling mark group 403 arranged in the mark area 300 of the third sub-border area 4023 can be used to detect the assembling deviation in one preset direction, that is, the assembling deviation in the longitudinal direction or the horizontal direction. Of course, the assembling mark group 403 arranged in the mark area 300 of the first sub-border area 4021 can also be used to detect the assembling deviation in one preset direction, and the assembling mark groups 403 arranged in the mark areas 300 of the third sub-border area 4023 can be used to detect the assembling deviations in two preset directions.

Of course, in the example B, the first sub-border area 4021 and the third sub-border area 4023 can also be sub-border areas 402 extending in the longitudinal direction of the display panel 400.

Using this example B, it is possible to detect the assembling deviations in the longitudinal direction and the horizontal direction in a single extension direction (longitudinal or horizontal) of the display panel 400 and according to the alignment of the comb teeth in the longitudinal direction and the horizontal direction at the same time, so that when the display panel 400 lacks space in a certain dimension direction (for example, the horizontal direction), the assembling deviations can be detected in two dimension directions, namely the longitudinal direction and the horizontal direction, by simultaneously arranging the assembling mark groups 403 in the dimension direction (for example, the longitudinal direction) with free space at the same time, thereby solving the problem of missing detection dimensions caused by limited space in either direction, and fully utilizing the space in the border area 402 provided by the display panel 400.

In a specific example C of the embodiment, the plurality of mark areas 300 can be distributed in the sub-border areas 402 on three sides of the display area 401, respectively, and one sub-border area 402 may have one or more spaced mark areas 300. As shown in FIG. 5c, the border area 402 includes a first sub-border area 4021 located on one side of the display area 401, a second sub-border area 4022 adjacent to the first sub-border area 4021, and a third sub-border area 4023 opposite to the first sub-border area 4021. The first sub-border area 4021, the second sub-border area 4022 and the third sub-border area 4023 each include one or more spaced mark areas 300, and the number of the mark areas 300 included in the three sub-border areas 402 may be different.

In the example C, preset directions in which the detection is performed by the assembling mark groups 403 arranged in the mark areas 300 of the first sub-border area 4021 and the third sub-border area 4023 can be the extension direction of the first sub-border area 4021. As shown in FIG. 5c, the extension direction of the first sub-border area 4021 and the third sub-border area 4023 is the horizontal direction when the display panel 400 is viewed from above. The preset direction in which the detection is performed by the assembling mark group 403 arranged in the mark area 300 of the second sub-border area 4022 may be an extension direction of the second sub-border area 4022. As shown in FIG. 5c, the extension direction of the second sub-border area 4022 is the longitudinal direction when the display panel 400 is viewed from above.

Of course, in the example C, the assembling mark groups 403 can also be arranged in the mark areas 300 of the first sub-border area 4021 or the third sub-border area 4023 to detect the assembling deviation in the extension direction of the second sub-border area 4022, for example, the assembling mark groups 403 in the longitudinal direction. In this way, the assembling deviation in the same preset direction can be detected at a plurality of position points, thereby improving the accuracy of detecting the assembling deviation, for example, the case that the assembling deviations at different position points are different due to the rotational dislocation between the first substrate 100 and the second substrate 200 can be detected.

In a specific example D of the embodiment, the plurality of mark areas 300 can be distributed in the sub-border areas 402 on four sides of the display area 401, respectively, and one sub-border area 402 may have one or more spaced mark areas 300. As shown in FIG. 5d, the border area 402 includes a first sub-border area 4021 located on one side of the display area 401, a second sub-border area 4022 and a fourth sub-border area 4024 adjacent to the first sub-border area 4021, and a third sub-border area 4023 opposite to the first sub-border area 4021.

The first sub-border area 4021, the second sub-border area 4022, the third sub-border area 4023, and the fourth sub-border area 4024 each include one or more spaced mark areas 300, and the number of the mark areas 300 included in the four sub-border areas 402 may be different.

In the example D, preset directions in which the detection is performed by the assembling mark groups 403 arranged in the mark areas 300 of the first sub-border area 4021 and the third sub-border area 4023 can be the extension direction of the first sub-border area 4021. As shown in FIG. 5d, the extension direction of the first sub-border area 4021 and the third sub-border area 4023 is the horizontal direction when the display panel 400 is viewed from above. Preset directions in which the detection is performed by the assembling mark groups 403 arranged in the mark areas 300 of the second sub-border area 4022 and the fourth sub-border area 4024 can be the extension direction of the second sub-border area 4022. As shown in FIG. 5d, the extension direction of the second sub-border area 4022 and the fourth sub-border area 4024 is the longitudinal direction when the display panel 400 is viewed from above.

The example D is suitable for a display panel 400 with sufficient space in the border area 402, so that the assembling mark groups 403 can be evenly arranged at four positions of the border area 402 to detect the assembling deviations.

As shown in FIG. 5 e, in an example E, the display panel 400 can be a three-sided borderless display panel 400, and the border area 402 includes a sub-border area 402 located on one side of the display area 401. The sub-border area 402 includes two mark areas 300, the two mark areas 300 are arranged near two different sides of the sub-border area 402, and the two different sides are oppositely arranged in the extension direction of the sub-border area 402.

At least two mark areas 300 are used to detect the assembling deviations in two mutually perpendicular preset directions.

In the embodiment, the sub-border area 402 located on one side of the display area 401 may refer to an area surrounding one side of the display area 401. As shown in FIG. 5e, the area may be a DP side area of the display panel 400 close to the display area 401. In some examples, when viewed from the top of the display panel 400, the extension direction of the sub-border area 402 may be the longitudinal direction or the horizontal direction. The plurality of mark areas 300 can be arranged in the sub-border area 402 at intervals.

The sub-border area 402 can be provided with at least two mark areas 300. If two mark areas 300 are included, the two mark areas 300 are arranged near the two different sides of the sub-border area 402, and the two different sides are oppositely arranged in the extension direction of the sub-border area 402. As shown in FIG. 5e, the two different sides near the sub-border area 402 can be a first side and a second side. The first side and the second side can be regarded as two corner areas of the sub-border area 402, that is, the two corner areas of the sub-border area 402 are provided with mark areas 300, and one corner area can be provided with at least one mark area 300.

In order to realize the assembling mark group 403 arranged in the sub-border area 402 on one side can detect assembling deviations in different preset directions, in a specific example of the embodiment, different mark areas 300 can be provided with assembling mark groups 403 for detecting the assembling deviations in different preset directions. For example, the sub-border area 402 includes two mark areas 300, and the two mark areas 300 are arranged near the two different sides of the sub-border area 402, then one of the two mark area 300 can be used to arrange assembling marker groups 403 for detecting the assembling deviation in a preset direction (for example, the horizontal direction), and the other mark area 300 can be used to arrange assembling marker groups 403 for detecting the assembling deviation in different preset direction (for example, the longitudinal direction).

In another specific example of the embodiment, each mark area 300 can be provided with assembling mark groups 403 for detecting assembling deviations in a plurality of different preset directions. For example, the sub-border area 402 includes two mark areas 300, and the two mark areas 300 are arranged near two different sides of the sub-border area 402, then each mark area 300 can be used to arrange assembling marker groups 403 for detecting horizontal assembling deviations and assembling marker groups 403 for detecting longitudinal assembling deviations.

Using the display panel 400 in the embodiment, the assembling mark groups 403 for detecting the assembling deviations in two preset directions can be arranged in the border area 402 on one side of the display panel 400, so that under the condition that the space of the border area 402 of the display panel 400 is relatively small, the setting of the assembling marker groups 403 for detecting the assembling deviations in two preset directions can be realized by using relatively little space, thereby fully utilizing the space provided by the border area 402 of the display panel 400.

As shown in the above embodiment, each mark area 300 can be provided with one or more assembling mark groups 403. For each mark area 300, at least one assembling mark group 403 included in the mark area 300 may include an assembling mark group 403 for detecting a single preset direction, or assembling mark groups 403 for detecting different preset directions.

That is, one mark area 300 can be used to detect the assembling deviation in the single preset direction, or can be used to detect the assembling deviations in two mutually perpendicular preset directions. In this way, at least one assembling mark group 403 included in the mark area 300 includes the first assembling mark group and/or the second assembling mark group. The preset direction corresponding to the first assembling mark group is the first direction, and the preset direction corresponding to the second assembling mark group is the second direction, where the first direction and the second direction are two directions perpendicular to each other.

In an example of the embodiment, the mark area 300 may include an assembling mark group 403, and the assembling mark group 403 is the first assembling mark group or the second assembling mark group, as shown in the above example A, example C and example D.

In another example of the embodiment, the mark area 300 may include two assembling mark groups 403, and the two assembling mark groups 403 may both be the first assembling mark group or the second assembling mark group, as shown in the above example A, example C and example D.

In yet another example of the embodiment, the mark area 300 may include two assembling mark groups 403, and the two assembling mark groups 403 may include the first assembling mark group and the second assembling mark group, as described in the above example shown in FIG. 5e.

In the embodiment, the preset direction corresponding to the first assembling mark group is the first direction, and the preset direction corresponding to the second assembling mark group is the second direction, where the first direction and the second direction are two directions perpendicular to each other.

As shown in FIG. 5a to FIG. 5e, the first direction can be the longitudinal direction when the display panel 400 is viewed from above, and the second direction can be the horizontal direction when the display panel 400 is viewed from above; alternatively, the first direction can be the horizontal direction when the display panel 400 is viewed from above, and the second direction can be the longitudinal direction when the display panel 400 is viewed from above.

Therefore, one mark area 300 can be used to detect the assembling deviations in two preset directions, thereby improving the number of position points of the assembling mark groups 403, and improving the accuracy of detecting the assembling deviations by detecting the assembling deviation in the preset direction using the assembling mark groups 403 arranged at different positions.

Hereinafter, the shape setting of the assembling mark group 403 will be introduced.

In some embodiments, the display panel 400 further includes a display area 401, the border area 402 includes a sub-border area 402 located on at least one side of the display area 401, and at least one mark area 300 can be located in the sub-border area 402, respectively. Specifically, the mark areas 300 can be distributed in manners of the above examples A to D.

In a third assembling mark group 403 of the plurality of assembling mark groups 403, the first assembling mark 103 and the second assembling mark 203 include a plurality of comb teeth which are continuous and uninterrupted, and a preset direction corresponding to the third assembling mark group 403 is parallel to an extension direction of the sub-border area 402 where the third assembling mark group 403 is located.

Specifically, in the example, the preset direction in which the third assembling mark group 403 detects the assembling deviation is parallel to the extension direction of the sub-border area 402 where the third assembling mark group 403 is located. For example, the third assembling mark group 403 is used to detect the assembling deviation in the horizontal direction, and the sub-border area 402 where the third assembling mark group 403 is located is the border area 402 in the horizontal direction, that is, there is enough space in the horizontal direction for the comb teeth in the third assembling mark group 403 to be arranged in the horizontal direction, and thus the first assembling mark 103 and the second assembling mark 203 in the third assembling mark group 403 may include the plurality of continuous and uninterrupted comb teeth. That is, the comb teeth of the first assembling mark 103 and the second assembling mark 203 are not divided and are arranged as a whole on the sub-border area 402.

For example, taking the example A shown in FIG. 5a as an example, the preset direction in which the detection is performed by the assembling mark group 403 arranged in the mark area 300 of the first sub-border area 4021 may be the extension direction of the first sub-border area 4021. If it is the horizontal direction, the assembling mark group 403 in the first sub-border area 4021 is the third assembling mark group 403. The first assembling mark 103 and the second assembling mark 203 included in the third assembling mark group 403 are continuous and uninterrupted comb teeth, and the continuous and uninterrupted comb teeth are arranged in the horizontal direction. Similarly, for the second sub-border area 4022 in FIG. 5a, the extension direction of the second sub-border area 4022 is longitudinal, and the assembling mark group 403 in the second sub-border area 4022 is also used to detect the assembling deviation in the longitudinal direction, and thus the assembling mark group 403 in the second sub-border area 4022 is the third assembling mark group 403. The first assembling mark 103 and the second assembling mark 203 included in the third assembling mark group 403 are continuous and uninterrupted comb teeth, and the continuous and uninterrupted comb teeth are arranged in the longitudinal direction.

In some embodiments, in the case where the space provided by the border area 402 is insufficient, it is necessary to detect the assembling deviations in two preset directions. For example, in the case where the mark areas 300 are all distributed in the sub-border area 402 on one side of the display area 401, at least two assembling mark groups 403 need to be arranged in the sub-border area 402 to detect the assembling deviations in the two preset directions.

Since the two preset directions are perpendicular to each other, for example, the horizontal direction and the longitudinal direction, it is necessary to arrange a comb shaped assembling mark group 403 in the longitudinal direction and a comb shaped assembling mark group 403 in the horizontal direction. In practice, the comb shaped assembling mark group 403 in the horizontal direction or the comb shaped assembling mark group 403 in the longitudinal direction can be split according to the extension direction of the sub-border area 402, and then the split assembling mark group 403 can be arranged in the extension direction of the sub-border area 402.

Of course, in some embodiments, for the detection of assembling deviations in the same preset direction at a plurality of different positions, in the case where a preset direction in which the detection is performed by an assembling mark group 403 arranged in a sub-border area 402 is perpendicular to the extension direction of the sub-border area 402, as shown in the above example B, the assembling mark groups 403 arranged in the mark areas 300 of the first sub-border area 4021 are used to detect the assembling deviations in two preset directions, and the assembling mark groups 403 arranged in the mark areas 300 of the third sub-border area 4023 can also be used to detect the assembling deviations in two preset directions. In the case where the extension directions of the first sub-border area 4021 and the third sub-border area 4023 are the horizontal directions, there is not enough space in the longitudinal direction for the assembling mark group 403 that detects the assembling deviation in the longitudinal direction, and thus the first assembling mark 103 and the second assembling mark 203 in the assembling mark group 403 can be split, and the split sub-assembling marks can be arranged in the horizontal direction, so that the sufficient horizontal space is utilized to arrange the assembling mark groups 403 required to be arranged in the longitudinal direction to detect the assembling deviation in the longitudinal direction.

Specifically, in the embodiment, the display panel 400 further includes a display area 401, the border area 402 includes a sub-border area 402 located on one side of the display area 401, and at least one mark area 300 is all located in the sub-border area 402. A fourth assembling mark group 403 of the plurality of assembling mark groups 403 includes: a plurality of sub-assembling mark groups 403 arranged at intervals in the extension direction of the sub-border area 402, where a preset direction corresponding to the fourth assembling mark group 403 is perpendicular to the extension direction of the sub-border area 402.

The plurality of sub-assembling mark groups 403 are obtained by segmenting the comb teeth of the first assembling mark 103 and the comb teeth of the second assembling mark 203.

In the embodiment, for the three-sided borderless display panel 400, that is, only one side of the display area 401 of the display panel 400 is provided with a sub-border area 402, and all the assembling mark groups 403 need to be arranged in the sub-border area 402 to detect the assembling deviations in two preset directions. Therefore, the space in the sub-border area 402 needs to accommodate comb shaped assembling marks arranged in two preset directions. For the fourth assembling mark group 403 in the assembling marks, since the preset direction detected by the fourth assembling mark group 403 is perpendicular to the extension direction of the sub-border area 402, that is, the arrangement direction of the comb teeth of the fourth assembling mark group 403 is perpendicular to the extension direction of the sub-border area 402, in this case, the space provided by the sub-border area 402 for the assembling marks in the preset direction is not enough.

For example, it is necessary to provide a plurality of assembling mark groups 403 in the sub-border area 402 extending horizontally. For the assembling mark group 403 (that is, the third assembling mark group 403) that detects the assembling deviation in the horizontal direction, as shown in FIG. 5a to FIG. 5e, since the comb teeth of the assembling mark group 403 are arranged in the horizontal direction, sufficient space will be provided for the assembling mark group 403; and for the assembling mark group 403 (that is, the fourth assembling mark group 403) that detects the assembling deviation in the longitudinal direction, since the comb teeth of the assembling mark group 403 need to be arranged in the longitudinal direction, the sub-border area 402 does not have enough space in the longitudinal direction.

In the embodiment, the comb teeth of the first assembling mark 103 and the comb teeth of the second assembling mark 203 included in the fourth assembling mark group 403 can be segmented. Specifically, after the comb teeth of the first assembling mark 103 are segmented, a plurality of segments of first sub-assembling marks can be obtained; and after the comb teeth of the second assembling mark 203 are segmented, a plurality of segments of second sub-assembling marks can be obtained. The first sub-assembling marks and the second sub-assembling marks are all comb shaped, where the number of first sub-assembling marks and the number of second sub-assembling marks are the same, and the plurality of first sub-assembling marks and the plurality of second sub-assembling marks are respectively combined to obtain a plurality of sub-assembling mark groups 403. The number of comb teeth included in the first sub-assembling mark is the same as the number of comb teeth included in the second sub-assembling mark in each of the plurality of sub-assembling mark groups 403.

That is, the plurality of sub-assembling mark groups 403 constitute the fourth assembling mark group 403, and the plurality of sub-assembling mark groups 403 can be arranged at intervals in the extension direction of the sub-border area 402, and thus the assembling mark group 403 for detecting the assembling deviation in the preset direction perpendicular to the extension direction can be arranged in the extension direction of the sub-border area 402 using the space provided by the sub-border area 402 in the extension direction of the sub-border area 402, so that under the condition that the space provided by the border area 402 is insufficient, even the space in one dimension direction is missing, the layout of the assembling mark groups 403 in both horizontal and longitudinal dimensions can be realized by dividing the assembling mark groups 403, thereby realizing the detection of the assembling deviations in the two dimension directions, and solving the problem that the detection dimension is missing due to the limited space in any direction in the related art.

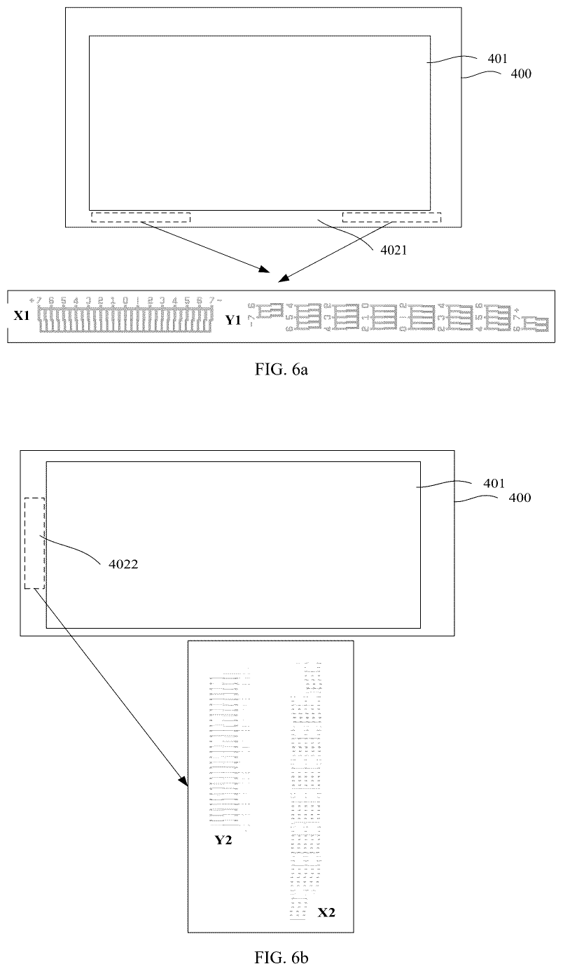

Referring to FIG. 6a and FIG. 6b, FIG. 6a shows a top plan view schematic diagram of a display panel 400 when an assembling mark group 403 is segmented in a horizontal direction, and FIG. 6b shows a top plan view schematic diagram of a display panel 400 when an assembling mark group 403 is segmented in a longitudinal direction.

As shown in FIG. 6a, all the assembling mark groups 403 are arranged in the sub-border area 402 extending horizontally. For the third assembling mark group X1 that detects the assembling deviation in the horizontal direction, the first assembling mark 103 and the second assembling mark 203 included in the third assembling mark group X1 include a plurality of continuous and uninterrupted comb teeth; and for the fourth assembling mark group Y1 that detects the assembling deviation in the longitudinal direction, the fourth assembling mark group Y1 includes a plurality of sub-assembling mark groups 403 arranged in the horizontal direction, and each of the plurality of sub-assembling mark groups 403 can be regarded as a segment of comb teeth after the first assembling mark 103 is split and a segment of comb teeth after the second assembling mark 203 is split.

As shown in FIG. 6b, all the assembling mark groups 403 are arranged in the sub-border area 402 extending longitudinally. For the third assembling mark group Y2 that detects the assembling deviation in the longitudinal direction, the first assembling mark 103 and the second assembling mark 203 included in the third assembling mark group Y2 include a plurality of continuous and uninterrupted comb teeth; and for the fourth assembling mark group X2 that detects the assembling deviation in the horizontal direction, the fourth assembling mark group X2 includes a plurality of sub-assembling mark groups 403 arranged in the horizontal direction, and each of the plurality of sub-assembling mark groups 403 can be regarded as a segment of comb teeth after the first assembling mark 103 is split and a segment of comb teeth after the second assembling mark 203 is split.

It should be noted that a size of each segment of the sub-assembling mark groups 403 in the preset direction is less than a size of the sub-border area 402 in the preset direction. For example, as shown in FIG. 6a, a height of each of the plurality of sub-assembling mark groups 403 in the longitudinal direction is less than a height of a space reserved in the sub-border area 402. As shown in FIG. 6b, a width of each sub-assembling mark group 403 in the horizontal direction is less than a width of the space reserved in the sub-border area 402.

Hereinafter, the morphology of the comb teeth included in the first assembling mark 103 and the second assembling mark 203 mentioned in the present disclosure will be described.

In some embodiments, a tooth width of the comb teeth in the first assembling mark 103 is greater than or equal to 5 μm, and a tooth width of the comb teeth in the second assembling mark 203 is greater than or equal to 5 μm.

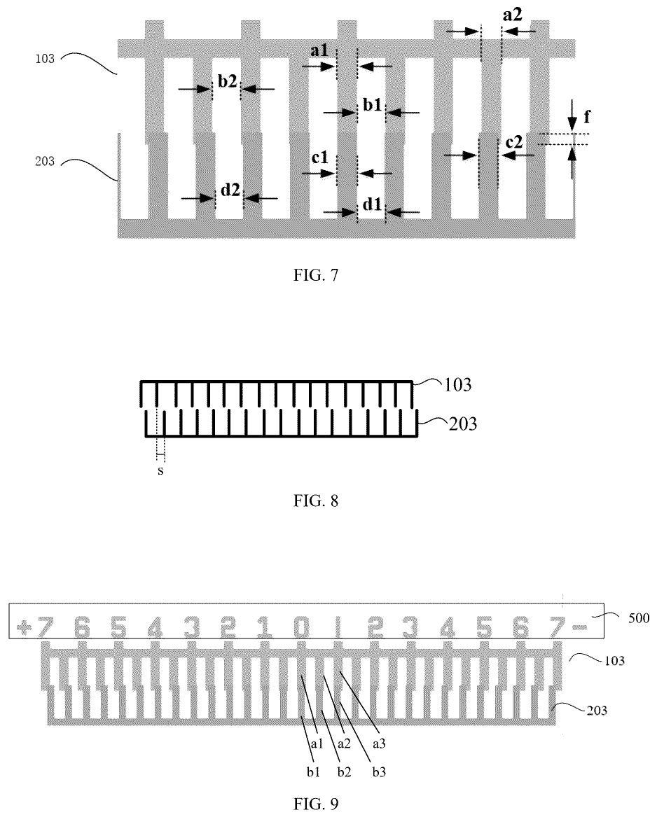

Referring to FIG. 7, FIG. 7 shows a top view schematic diagram of an assembling mark group 403 for detecting an assembling deviation in a horizontal direction. As shown in FIG. 7, the assembling mark group 403 includes a first assembling mark 103 and a second assembling mark 203, where the first assembling mark 103 and the second assembling mark 203 are continuous and uninterrupted comb shaped. The tooth width of the comb teeth in the first assembling mark 103 can be understood as a line width of the comb teeth, and the tooth width can be greater than or equal to 5 μm to ensure the recognition effect under an optical microscope. Similarly, the tooth width of the comb teeth in the second assembling mark 203 can also be greater than or equal to 5 μm.

In general, the theoretical minimum resolution of the optical microscope is 0.2 μm. In order to ensure a relatively good recognition effect under the optical microscope, a minimum size of the tooth width can be 5 μm. Of course, in order to ensure that the assembling mark does not occupy more space, a maximum size of the tooth width can be 10 μm.

In still other embodiments, a spacing distance between a plurality of comb teeth in the first assembling mark 103 may be equal, and/or the plurality of comb teeth may have the same size; and a spacing distance between a plurality of comb teeth in the second assembling mark 203 is equal, and/or the plurality of comb teeth have the same size.

In this embodiment, in order to ensure the accuracy of measuring the assembling deviation, the spacing distance between the plurality of comb teeth in the first assembling mark 103 may be the same, and sizes of the plurality of comb teeth in the first assembling mark 103 may also be the same. The sizes here may include the line width of the comb teeth and a length of the comb teeth. That is, the line widths and the lengths of the plurality of comb teeth are the same.

In some examples, the spacing distance between the plurality of comb teeth in the first assembling mark 103 may be different, but the sizes of the plurality of comb teeth in the first assembling mark 103 are the same. In this case, the spacing distance between the plurality of comb teeth can be varied in multiples, for example, a spacing distance between comb teeth 1 and 2 is half a spacing distance between the comb teeth 2 and comb teeth 3. In this case, it can be used as an assembling mark for a display panel 400 with low requirements for the assembling deviation. When measuring, it is convenient for the users to identify the alignment of comb teeth, and it is suitable for the display panel 400 with low requirements for the assembling deviation, for example, the assembling deviation is required to be with in ±10 μm in the display panel 400.

Of course, for the second assembling mark 203, the spacing distance between the plurality of comb teeth in the second assembling mark 203 may be the same, and sizes of the plurality of comb teeth in the second assembling mark 203 may also be the same.

Moreover, in the case where the sizes of the plurality of comb teeth in the first assembling mark 103 are the same, the sizes of the plurality of comb teeth in the second assembling mark 203 should also be the same, so as to facilitate the measurement of the assembling deviation according to the alignment of the comb teeth of the first assembling mark 103 and the second assembling mark 203.

Since it is necessary to measure the assembling deviation based on the alignment of the comb teeth of the first assembling mark 103 and the comb teeth of the second assembling mark 203, in some examples, the sizes of the plurality of comb teeth in the first assembling mark 103 may be the same as the sizes of the plurality of comb teeth in the second assembling mark 203. Specifically, the same size can include:
the line width of the comb teeth in the first assembling mark 103 is the same as the line width of the comb teeth in the second assembling mark 203, but the length may be different;
the length of the comb teeth in the first assembling mark 103 is the same as the length of the comb teeth in the second assembling mark 203, and the line width of the comb teeth in the first assembling mark 103 is the same as the line width of the comb teeth in the second assembling mark 203.

As mentioned above, in the case where the spacing distance between the comb teeth of the first assembling mark 103 is the same, the spacing distance between the comb teeth of the second assembling mark 203 should also be the same. In the case where the spacing distance between the plurality of comb teeth in the first assembling mark 103 is equal, in some embodiments, a first spacing distance between every two adjacent comb teeth in the first assembling mark 103 is greater than or equal to 5 μm, and a second spacing distance between every two adjacent comb teeth in the second assembling mark 203 is greater than or equal to 5 μm.

In the embodiment, in the case where the spacing distance between the comb teeth is greater than or equal to 5 μm, the recognition effect of the alignment of the comb teeth can be ensured under the optical microscope. Of course, the maximum spacing distance between the comb teeth can be limited to 10 μm, which can be determined based on a range of the assembling deviation that needs to be recognized and a size of the space provided by the frame area 402.

Specifically, the first spacing distance may be greater than or equal to 5 μm and less than or equal to 10 μm, and the second spacing distance may also be greater than or equal to 5 μm and less than or equal to 10 μm.

In some embodiments, the first spacing distance may be the same as or different from the second spacing distance.

In the case where the first spacing distance is the same as the second spacing distance, the assembling deviation can be determined based on an offset distance between misaligned comb teeth. For example, referring to FIG. 8, FIG. 8 shows a principle schematic diagram of measuring an assembling deviation in this case. As shown in FIG. 8, the sizes of a plurality of comb teeth in the first assembling mark 103 are the same, and the first spacing distance between the plurality of comb teeth is the same; the sizes of a plurality of comb teeth in the second assembling mark 203 are the same, and the second spacing distance between the plurality of comb teeth is the same; the size of the comb teeth in the first assembling mark 103 is the same as the size of the comb teeth in the second assembling mark 203, and the first spacing distance and the second spacing distance are the same. As shown in FIG. 8, the first assembling mark 103 and the second assembling mark 203 are not completely aligned, and there is a deviation between the first assembling mark 103 and the second assembling mark 203, that is, the comb teeth of the first assembling mark 103 and the comb teeth of the second assembling mark 203 are misaligned. In this case, the assembling deviation can be determined based on an offset S between the misaligned comb teeth. For example, if the offset between the comb teeth is 0.5 μm, the assembling deviation can be determined to be 0.5.

The measurement of offset can be determined by using the related art, and the details are not repeated here.

In the case where the first spacing distance and the second spacing distance are different, the assembling deviation can be determined based on the aligned comb teeth. In this case, in order to facilitate the manual measurement of the assembling deviation in the preset direction based on the assembling mark group 403, a plurality of scale marks 500 can be arranged on each assembling mark group 403. A numerical range of the plurality of scale marks 500 can be set according to a detection range of the assembling deviation.

Specifically, in the case where the first spacing distance is different from the second spacing distance, the assembling mark group 403 further includes: a plurality of scale marks 500, and the plurality of scale marks 500 are located on one side of the first assembling mark 103 away from the second assembling mark 203, or on one side of the second assembling mark 203 away from the first assembling mark 103;
where two adjacent scale marks 500 pass through at least two comb teeth, and a difference between scales of the two adjacent scale marks 500 is a product of a difference between the first spacing distance and the second spacing distance and a number of comb teeth.

The plurality of scale marks 500 may be located on the first substrate 100 or the second substrate 200, preferably, on the array substrate side of the display panel 400. Specifically, the plurality of scale marks 500 can be located on one side away from an orientation direction of the comb teeth. Referring to FIG. 9, FIG. 9 shows a top view schematic diagram of an assembling mark group 403 with scale marks 500. The plurality of scale marks 500 are located on one side of an orientation direction of the comb teeth in the first assembling mark 103, that is, on one side opposite to the orientation direction of the comb teeth. The scale marks 500 are arranged to prevent the scale marks 500 from being blocked by the comb teeth of the other substrate after the first substrate 100 and the second substrate 200 are aligned, thereby facilitating the users to read the scale marks 500.

As shown in FIG. 9, taking the detection of the assembling deviation in the horizontal direction as an example, a spacing distance between every two adjacent scale marks 500 is the same, and the two adjacent scale marks 500 pass through at least two comb teeth, that is, at least two comb teeth need to be included between the two adjacent scale marks 500. Specifically, in the at least two comb teeth, the comb teeth including corresponding positions of the scale marks can also be understood as the comb teeth facing the scale marks, which means that the scale marks are arranged on an extension line of the length direction of the comb teeth. If the two adjacent scale marks include two comb teeth, the two scale marks can both be arranged on the extension line of the length direction of the comb teeth, that is, the two scale marks are opposite to the comb teeth. If the two adjacent scale marks include a plurality of comb teeth, the two scale marks can be arranged on the extension line of the length direction of the comb teeth located at both ends in the plurality of comb teeth.

In some examples, each of the scale marks 500 is arranged on the extension line of the length direction of the comb teeth, that is, on the extension line of the comb teeth opposite to the orientation direction. Specifically, a scale mark 500 can be arranged on the extension line of each comb tooth, so that every two scale marks 500 can correspond to two comb teeth; alternatively, every three comb teeth correspond to two scale marks 500, that is, a scale mark 500 is arranged at intervals of one comb tooth. As shown in FIG. 9, three comb teeth correspond to two scale marks 500.

In the embodiment, each scale mark 500 may correspond to its own scale value. In some examples, a plurality of scale marks 500 may include a first scale mark 500 with “0”, and first scale mark 500 may be arranged on an extension line of a comb tooth located at a center position in the plurality of comb teeth. Next, in the plurality of scale marks 500, second scale marks 500 except the first scale mark 500 can be sequentially arranged along a preset direction with the first scale mark 500 as the center, and from the first scale mark 500, scale values corresponding to the second scale marks 500 sequentially arranged along the preset direction are varied arithmetically, for example, the closer to the first scale mark 500, the smaller the scale values, thereby forming the scales of the assembling mark group 403. As shown in FIG. 9, the first scale mark 500 in the scale marks 500 is “0”, and a plurality of second scale marks 500 are arranged on left and right sides of the first scale mark 500 in sequence, and the scale values show an arithmetic change in turn.

Since the first spacing distance between the comb teeth in the first assembling mark 103 is different from the second spacing distance between the comb teeth in the second assembling mark 203, in practice, the aligned comb teeth can represent a range where the assembling deviation occurs. Specifically, the difference between the scales of two adjacent scale marks 500 may be the product of the difference between the first spacing distance and the second spacing distance and the number of comb teeth between the two scale marks 500. In this way, the assembling deviation can be determined directly according to the scale marks 500 corresponding to the aligned comb teeth.

For example, as shown in FIG. 9, at “1” of the scale mark 500, the comb teeth of the first assembling mark 103 and the comb teeth of the second assembling mark 203 are aligned. Assuming that a deviation between the first spacing distance and the second spacing distance is 0.5 μm, from “0” of the scale mark 500 to “1” of the scale mark 500, there are three comb teeth, including a comb tooth a1, a comb tooth a2 and a comb tooth a3 in the first assembling mark 103, and a comb tooth b1, a comb tooth b2 and a comb tooth b3 in the second assembling mark 203. Since the difference of the spacing distance between the three pairs of comb teeth is 0.5 μm, the offset is 1 μm when the comb tooth b3 and the comb tooth a3 are aligned, which indicates that there is an assembling deviation of 1 μm, and the 1 μm is just the scale value corresponding to the scale mark 500. Therefore, the assembling deviation can be determined directly according to the scale marks 500 corresponding to the aligned comb teeth.

Of course, if no scale mark 500 is arranged at the aligned comb teeth, the scale value of the aligned comb teeth can be determined according to the two scale marks 500 closest to the aligned comb teeth. For example, if the aligned comb teeth are the comb tooth a2, then the two scale marks 500 near the comb tooth a2 are “0” and “1” of the scale marks 500, respectively, and it can be determined that the scale corresponding to the comb tooth a2 is 0.5.

It should be noted that a scale range of the scale marks 500 in the embodiment can be determined according to a detection range of the assembling deviation. For example, as shown in FIG. 9, the detection range of the assembling deviation is ±7 μm, and the numerical range of the scales corresponding to the scale marks 500 is also ±7 μm.

Specifically, in the embodiment, the difference between the first spacing distance and the second spacing distance can represent the detection accuracy of detecting the assembling deviation. For the same detection range of the assembling deviation, the smaller the difference between the first spacing distance and the second spacing distance, the higher the detection accuracy and the finer the detection of the assembling deviation.

For example, the detection range of the assembling deviation is ±7 μm. If the difference between the first spacing distance and the second spacing distance is 0.2 μm, the detection accuracy is 0.2 μm, which means that it can detect the smallest assembling deviation of 0.2 μm; and if the difference between the first spacing distance and the second spacing distance is 0.5 μm, the detection accuracy is 0.5 μm, which means that it can detect the smallest assembling deviation of 0.5 μm. It can be understood that the smaller the detection accuracy, the finer the detection of the assembling deviation, and the subtlety of detecting the assembling deviation can be improved.

In some examples, the difference between the first spacing distance and the second spacing distance can be set to be greater than or equal to 0.2 μm and less than or equal to 2 μm. That is, the detection accuracy of the assembling deviation can be 0.2 μm at the highest and 2 μm at the lowest, and the detection accuracy ranges from 0.2 μm to 2 μm.

The setting of the detection range of the assembling deviation can be independent of the setting of the detection accuracy. In an optional example, the larger the detection range of the assembling deviation, the greater the detection accuracy can be set, that is, the greater the difference between the first spacing distance and the second spacing distance, the smaller the detection range of the assembling deviation, the higher the detection accuracy can be set, that is, the smaller the difference between the first spacing distance and the second spacing distance.

For example, if the detection range of the assembling deviation is ±7 μm, which is a tolerable range of the assembling deviation at present, the detection accuracy can be set to 0.5 μm. If the detection range of the assembling deviation is +5 μm, which is for display devices with relatively high requirements for the assembling deviation, the detection accuracy can be set to 0.3 μm to improve the accuracy of the assembling deviation.

In some embodiments, in order to facilitate the users to observe the alignment of the comb teeth, generally, in the case where the aligned comb teeth have overlapping areas, colors of the overlapping areas are relatively dark, and thus it is convenient for the users to observe. In a display panel 400, an orthographic projection of the comb teeth in the first assembling mark 103 on the second substrate 200 partially overlaps with the comb teeth in the second assembling mark 203.

Specifically, partial overlap may mean that the comb teeth in the first assembling mark 103 partially overlap with the comb teeth in the second assembling mark 203 in a direction that the first assembling mark 103 points the second assembling mark 203. In this case, after the first substrate 100 and the second substrate 200 are aligned, the comb teeth in the first assembling mark 103 and the comb teeth in the second assembling mark 203 may have overlapping areas.

The partial overlap can be understood as: partial areas of the comb teeth in the first assembling mark 103 are located in an area of the orthographic projection of the second assembling mark 203 on the first substrate 100, and partial areas of the comb teeth in the second assembling mark 203 are also located in an area of the orthographic projection of the first assembling mark 103 on the second substrate 200, and thus after assembling, the length of the comb teeth in one assembling mark (for example, the first assembling mark 103) can extend into the other assembling mark (for example, the second assembling mark 203) to overlap with the comb teeth in the other assembling mark.

As shown in FIG. 9, after the first substrate 100 and the second substrate 200 are aligned, the comb teeth in the first assembling mark 103 overlap with the comb teeth in the second assembling mark 203, and the colors of the overlapping areas are relatively dark, that is, the aligned comb teeth can be determined according to the areas with relatively dark color.

In a further example of the embodiment, a size of an overlapping area in a length direction of the comb teeth is greater than or equal to 2 μm and less than a length of the comb teeth. The lower limit of the overlapping area can be 2 μm, that is, the comb teeth in the first assembling mark 103 and the comb teeth in the second assembling mark 203 need to have a spatial overlap of at least 2 μm. The length of the comb teeth can be set according to requirements, and generally the length of the comb teeth can be greater than 10 μm.

It should be noted that the size of the overlapping area also needs to be less than the length of the comb teeth. Specifically, in the case where the length of the comb teeth of the first assembling mark 103 and the length of the comb teeth of the second assembling mark 203 are different, the size of the overlapping area needs to be less than the length of relatively short comb teeth in the first assembling mark 103 and the second assembling mark 203. For example, if the length of the comb teeth in the first assembling mark 103 is 10 μm, and the length of the comb teeth in the second assembling mark 203 is 12 μm, then the size of the overlapping area in the length direction of the comb teeth should be less than 10 μm.

Of course, in a further example of the embodiment, a color of the first assembling mark 103 is different from a color of the second assembling mark 203. Therefore, when the first assembling mark 103 overlaps with the second assembling mark 203, the overlapping area is a composite color of two colors, so that the alignment can be more clearly recognized.

In still other embodiments, the comb teeth in the first assembling mark 103 and the comb teeth in the second assembling mark 203 may be rectangular in shape, or free ends of the first assembling mark 103 and the second assembling mark 203 may be in a shape of spikes or arcs. Of course, in order to easily identify the alignment of the comb teeth, the shape of the comb teeth is preferably rectangular.

Taking the display panel 400 shown in FIG. 6a as an example, the display panel 400 in a specific example will be described.

The display panel 400 includes an array substrate and a color filter substrate. The array substrate includes a first display area 101 and a sub-border area 402 surrounding one side of the first display area 101. The color filter substrate includes a second display area 201 and a sub-border area 402 surrounding one side of the second display area 201. After the array substrate and the color filter substrate are aligned, the formed display panel 400 is a three-sided borderless display area 401. One side of the display panel 400 has a sub-border area 402, and the extension direction of the sub-border area 402 is the horizontal direction. It should be noted that the horizontal direction refers to a horizontal direction when the display panel 400 is viewed from above.

Two mark areas 300 are arranged at two side edges of the sub-border area 402, namely two corner areas, near the display area 401, respectively, and each of the two mark areas 300 includes two assembling mark groups 403. One of the two assembling mark groups 403 is used to detect the assembling deviation in the horizontal direction, and the other assembling mark group 403 is used to detect the assembling deviation in the longitudinal direction. The assembling mark group 403 that detects the assembling deviation in the horizontal direction is called an assembling mark group X1, and the assembling mark group 403 that detects the assembling deviation in the longitudinal direction is called an assembling mark group Y1.

The first assembling mark in the assembling mark group X1 is arranged in the same layer as a gate metal film layer of the array substrate, and the material of the first assembling mark may be the same as the material of the gate metal film layer, but the color of the first assembling mark is opaque, for example, colored. The second assembling mark in the assembling mark group X1 is arranged in the same layer as a black matrix film layer of the color filter substrate, and the material of the second assembling mark may be different from the material of the black matrix film layer, but the color of the second assembling mark is opaque.

The assembling mark group X1 includes a first assembling mark 103 in a comb shape in the horizontal direction and a second assembling mark 203 in a comb shape in the horizontal direction. The first assembling mark 103 is located on the array substrate, and the second assembling mark 203 is located on the color filter substrate. After assembling, comb teeth of the first assembling mark 103 face the second assembling mark 203, and comb teeth of the second assembling mark 203 face the first assembling mark 103. The comb teeth of the assembling mark group X1 are continuous and uninterrupted, and include a plurality of scale marks 500. A scale mark 500 with “0” in the plurality of scale marks 500 is located on a comb tooth at a center position point, and every other comb tooth corresponds to a scale mark 500. The scale mark 500 ranges from −7 μm to 7 μm, which indicates that the detection range of the assembling deviation is ±7 μm.

The assembling mark group Y1 includes a plurality of sub-assembling mark groups 403 arranged in the horizontal direction, which are obtained by splitting a plurality of comb teeth arranged in the longitudinal direction. For example, the first assembling mark 103 on the array substrate is split, the second assembling mark 203 located on the color filter substrate is split, and the split assembling mark group 403 is combined to obtain the plurality of sub-assembling mark groups 403. Each of the plurality of sub-assembling mark groups 403 corresponds to its own scale mark 500. After the plurality of sub-assembling mark groups 403 are arranged in the horizontal direction, the assembling deviation in the longitudinal direction can be detected based on the alignment of the comb teeth.

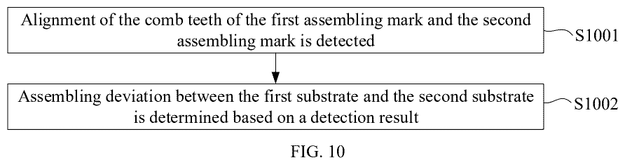

Based on the same inventive concept, the present disclosure further provides a method for measuring an assembling deviation of the display panel 400 in the above embodiment. Referring to FIG. 10, FIG. 10 shows a flowchart of steps of the method. As shown in FIG. 10, the method can specifically include the following steps:
step S1001, alignment of the comb teeth of the first assembling mark and the second assembling mark is detected; and
step S1002, an assembling deviation between the first substrate and the second substrate is determined based on a detection result.

In the embodiment, after the assembling process are performed on the first substrate 100 and the second substrate 200, the obtained display panel 400 can be placed under the optical microscope to observe the alignment of the comb teeth of the first assembling mark 103 and the second assembling mark 203.

Specifically, in the detection method shown in FIG. 8, the sizes of a plurality of comb teeth in the first assembling mark 103 are the same, and the first spacing distance between the plurality of comb teeth is the same; the sizes of a plurality of comb teeth in the second assembling mark 203 are the same, and the second spacing distance between the plurality of comb teeth is the same; the size of the comb teeth in the first assembling mark 103 is the same as the size of the comb teeth in the second assembling mark 203, and the first spacing distance and the second spacing distance are the same. Therefore, the assembling deviation can be determined based on the offset between the misaligned comb teeth.

The display panel can be placed under the optical microscope to observe the alignment of the comb teeth of the first assembling mark 103 and the second assembling mark 203.

As shown in FIG. 8, the first assembling mark 103 and the second assembling mark 203 are not completely aligned, and there is a deviation between the first assembling mark 103 and the second assembling mark 203, that is, the comb teeth of the first assembling mark 103 and the comb teeth of the second assembling mark 203 are misaligned. In this case, the assembling deviation can be determined based on an offset between the misaligned comb teeth. For example, if the offset between the comb teeth is 0.5 μm, the assembling deviation can be determined to be 0.5.

Specifically, in another detection method shown in FIG. 9, the sizes of a plurality of comb teeth in the first assembling mark 103 are the same, and the first spacing distance between the plurality of comb teeth is the same; the sizes of a plurality of comb teeth in the second assembling mark 203 are the same, and the second spacing distance between the plurality of comb teeth is the same; the size of the comb teeth in the first assembling mark 103 is the same as the size of the comb teeth in the second assembling mark 203, and the first spacing distance and the second spacing distance are different. This difference may mean that a value of the first spacing distance is not equal to a value of the second spacing distance. Therefore, the assembling deviation can be determined based on the offset between the aligned comb teeth.

In some embodiments, the offset corresponding to the aligned comb teeth can be directly represented by the corresponding scale marks 500. Specifically, target comb teeth that are completely aligned can be determined in the first assembling mark 103 and the second assembling mark 203; and the assembling deviation is determined based on a scale value corresponding to a target scale mark 500. As shown in FIG. 9, at “1” of the scale mark 500, the comb teeth of the first assembling mark 103 and the comb teeth of the second assembling mark 203 are aligned. Assuming that a deviation between the first spacing distance and the second spacing distance is 0.5 μm, from “0” of the scale mark 500 to “1” of the scale mark 500, there are three comb teeth, including a comb tooth a1, a comb tooth a2 and a comb tooth a3 in the first assembling mark 103, and a comb tooth b1, a comb tooth b2 and a comb tooth b3 in the second assembling mark 203. Since the difference of the spacing distance between the three pairs of comb teeth is 0.5 μm, the offset is 1 μm when the comb tooth b3 and the comb tooth a3 are aligned, which indicates that there is an assembling deviation of 1 μum, and the 1 μm is just the scale value corresponding to the scale mark 500. Therefore, the assembling deviation can be determined directly according to the scale marks 500 corresponding to the aligned comb teeth.

Based on the same inventive concept, the present disclosure further provides a display device. The display device may include the display panel described above.

Based on the same inventive concept, the present disclosure further provides a method for manufacturing the above display panel. The method may specifically include the following steps.
Step S1, a first base required by a first substrate is provided, and a plurality of structural layers are sequentially formed on the first substrate according to a first process of the first substrate to obtain the first substrate. In a first patterned film layer process of the first process, a first assembling mark in a comb shape is formed at one time in at least one mark area of a border area of the first substrate. The first patterned film layer process means that a film layer needs to be patterned for the first time on the first substrate. If it is an array substrate, the film layer is generally a first metal film of the first substrate, for example, a Gate film layer.
Step S2, a second base required by a second substrate is provided, and a plurality of structural layers are sequentially formed on the second substrate according to a second process of the second substrate to obtain the second substrate. In a first patterned film layer process of the second process, a second assembling mark in a comb shape is formed at one time at at least one position respectively corresponding to at least one mark area. The first patterned film layer process here means that a film layer needs to be patterned for the first time on the second substrate. If it is a color filter substrate, the film layer is generally a black matrix film layer.
Step S3, the first substrate and the second substrate are aligned to obtain the display panel.

Then, the assembling deviation of the display panel can be detected, and the detection method can be carried out through the above steps shown in FIG. 10.

Finally, it should be noted that in the present disclosure, relational terms such as “first” and “second” are merely intended to distinguish one entity or operation from another entity or operation, and do not necessarily require or imply any such actual relationship or order between these entities or operations. Moreover, terms “include”, “contain” or any variants thereof are intended to cover non-exclusive inclusions, so that processes, methods, articles or devices that include a series of elements do not only include those elements, but also include other elements that are not explicitly listed, or include the elements that are inherent to such processes, methods, articles or devices. Unless further limitation is set forth, an element defined by the wording “including a . . . ” does not exclude additional same element in the process, method, article or device including the element.

The above provides a detailed introduction to a display panel, a method for measuring an assembling deviation, and a display device provided by the present disclosure. Specific examples are applied in this specification to explain the principles and implementation methods of the present disclosure. The above examples are only used to help understand the method and core idea of the present disclosure. Meanwhile, for a person skilled in the art, there may be changes in specific implementation methods and application scope based on the ideas disclosed in the present disclosure. In summary, contents of this specification should not be understood as a limitation on the present disclosure.

After considering the specification and practicing the invention disclosed herein, a person skilled in the art will easily come up with other embodiments of the present disclosure. The present disclosure aims to cover any variations, uses, or adaptive changes of the present disclosure, which follow the general principles of the present disclosure and include common knowledge or customary technical means in the field of technology that are not disclosed in the present disclosure. The specification and embodiments are only considered exemplary, and the true scope and spirit of the present disclosure are indicated by the following claims.

It should be understood that the present disclosure is not limited to the precise structure mentioned above and shown in the drawings, and various modifications and changes can be made without departing from its scope. The scope of the present disclosure is limited only by the attached claims.

The term “one embodiment”, “an embodiment” or “one or more embodiments” referred to in this specification means that specific features, structures, or features described in conjunction with the embodiments are included in at least one embodiment of the present disclosure. Furthermore, note that the example of the term “in an embodiment” may not necessarily refer to the same embodiment.

In the specification provided here, a large number of specific details are explained. However, it can be understood that the embodiments of the present disclosure can be practiced without these specific details. In some examples, well-known methods, structures, and techniques are not shown in detail to avoid blurring the understanding of this specification.

In the claims, any reference symbol between parentheses should not be constructed as a limitation on the claims. The word “comprising” does not exclude the presence of components or steps not listed in the claims. The word “a/an” or “one” before a component does not exclude the existence of multiple such components. The present disclosure can be achieved through hardware comprising several different components and through appropriately programmed computers. Among the unit claims that list several devices, several of these devices can be specifically embodied through the same hardware item. The use of words such as first, second and third does not indicate any order. These words can be interpreted as names.

Finally, it should be noted that the above embodiments are merely intended to explain the technical solutions of the present disclosure, and not to limit them. Although the present disclosure is explained in detail with reference to the above embodiments, a person skilled in the art should understand that he can still modify the technical solutions set forth by the above embodiments, or make equivalent substitutions to part of the technical features of them. However, those modifications or substitutions do not make the essence of the corresponding technical solutions depart from the spirit and scope of the technical solutions of the embodiments of the present disclosure.

1. A display panel, comprising: a first substrate and a second substrate, wherein
the display panel comprises a display area and a non-display area, wherein at least one mark area is arranged in the non-display area, each of the at least one mark area comprises at least one assembling mark group, and each of the at least one assembling mark group is configured to detect an assembling deviation in a preset direction;
the assembling mark group comprises: a first assembling mark arranged on a side of the first substrate close to the second substrate and in a comb shape, and a second assembling mark arranged on a side of the second substrate close to the first substrate and in the comb shape,
wherein comb teeth of the first assembling mark face the second assembling mark, comb teeth of the second assembling mark face the first assembling mark, and a length direction of the comb teeth is perpendicular to the preset direction.

2. The display panel according to claim 1, wherein the non-display area comprises a border area, and the border area comprises a sub-border area located on at least one side of the display area,
wherein a plurality of mark areas are located in all or part of the sub-border area.

3. The display panel according to claim 1, wherein the non-display area comprises a border area, the border area comprises a sub-border area located on a side of the display area, the sub-border area comprises at least two mark areas, the at least two mark areas are arranged close to two different sides of the sub-border area, and the two different sides are oppositely arranged in an extension direction of the sub-border area,
wherein the assembling mark groups in the at least two mark areas are configured to detect an assembling deviation in two mutually perpendicular preset directions.

4. The display panel according to claim 1, wherein the at least one assembling mark group comprised in the mark area comprises at least one of a first assembling mark group or a second assembling mark group, a preset direction corresponding to the first assembling mark group is a first direction, and a preset direction corresponding to the second assembling mark group is a second direction,
wherein the first direction and the second direction are two mutually perpendicular directions.

5. The display panel according to claim 1, wherein the non-display area comprises a border area, the border area comprises one or more sub-border areas located on at least one side of the display area, and the at least one mark area is located in at least one of the sub-border areas,
wherein in a third assembling mark group in a plurality of assembling mark groups, the first assembling mark and the second assembling mark comprise a plurality of comb teeth which are continuous and uninterrupted, and
wherein a preset direction corresponding to the third assembling mark group is parallel to an extension direction of the sub-border area where the third assembling mark group is located.

6. The display panel according to claim 1, wherein the non-display area comprises a border area, the border area comprises a sub-border area located on one side of the display area, and the at least one mark area is all located in the sub-border area,
wherein a fourth assembling mark group in a plurality of assembling mark groups comprises: a plurality of sub-assembling mark groups arranged at intervals in an extension direction of the sub-border area, and the plurality of sub-assembling mark groups are obtained by segmenting the comb teeth of the first assembling mark and the comb teeth of the second assembling mark, and
wherein a preset direction corresponding to the fourth assembling mark group is perpendicular to the extension direction of the sub-border area.

7. The display panel according to claim 1, wherein a spacing distance between a plurality of comb teeth in the first assembling mark is equal, and the plurality of comb teeth have a same size; and
a spacing distance between a plurality of comb teeth in the second assembling mark is equal, and the plurality of comb teeth have a same size.

8. The display panel according to claim 1, wherein a first spacing distance between every two adjacent comb teeth in the first assembling mark is greater than or equal to 5um, and a second spacing distance between every two adjacent comb teeth in the second assembling mark is greater than or equal to 5 μm.

9. The display panel according to claim 8, wherein a value of the first spacing distance is not equal to a value of the second spacing distance, and the assembling mark group further comprises: a plurality of scale marks, and the plurality of scale marks are located on a side of the first assembling mark away from the second assembling mark or on a side of the second assembling mark away from the first assembling mark,
wherein two adjacent scale marks pass through at least two comb teeth, and a difference between scales of the two adjacent scale marks is a product of a difference between the first spacing distance and the second spacing distance and a number of comb teeth.

10. The display panel according to claim 8, wherein the first spacing distance is different from the second spacing distance, and a difference between the first spacing distance and the second spacing distance is greater than or equal to 0.2 μm and less than or equal to 2 μm.

11. The display panel according to claim 1, wherein an orthographic projection of the comb teeth in the first assembling mark on the second substrate partially overlaps with the comb teeth in the second assembling mark.

12. The display panel according to claim 11, wherein a size of an overlapping area in a length direction of the comb teeth is greater than or equal to 2 μm and less than a length of the comb teeth.

13. The display panel according to claim 1, wherein the first substrate is an array substrate, wherein the first assembling mark is arranged in a same layer as a metal film layer farthest from the second substrate in the array substrate.

14. The display panel according to claim 1, wherein the second substrate is a color filter substrate, wherein the second assembling mark is arranged in a same layer as a black matrix film layer of the color filter substrate.

15. The display panel according to claim 1, wherein a color of the first assembling mark is different from a color of the second assembling mark.

16. A method for measuring an assembling deviation, applied to the display panel according to claim 1, comprising:
detecting alignment of the comb teeth of the first assembling mark and the second assembling mark; and
determining an assembling deviation between the first substrate and the second substrate based on a detection result.

17. The method according to claim 16, wherein determining the assembling deviation between the first substrate and the second substrate based on the detection result comprises:
determining target comb teeth that are completely aligned in the first assembling mark and the second assembling mark; and
determining the assembling deviation based on a scale value corresponding to a target scale mark.

18. A display device, comprising: the display panel according to claim 1.

19. The display panel according to claim 9, wherein the first spacing distance is different from the second spacing distance, and a difference between the first spacing distance and the second spacing distance is greater than or equal to 0.2 μm and less than or equal to 2 μm.

20. The display panel according to claim 13, wherein the second substrate is a color filter substrate, wherein the second assembling mark is arranged in a same layer as a black matrix film layer of the color filter substrate.
